(19) United States
(12) Patent Application Publication
(10) Pub. No.: US 2024/0040535 A1
(43) Pub. Date: Feb. 1, 2024

(54) Safety System with Radio Location and Testing Device

(71) Applicant: Pilz GmbH & Co. KG, Ostfildern (DE)

(72) Inventors: Stefan LOY, Ostfildern (DE); Marcus FRITZMANN, Ostfildern (DE); Onedin IBROCEVIC, Ostfildern (DE); Jürgen PULLMAN, Ostfildern (DE)

(21) Appl. No.: 18/358,542

(22) Filed: Jul. 25, 2023

(30) Foreign Application Priority Data
Jul. 26, 2022 (DE) 102022118737.3

(51) Int. Cl. H04W 64/00; H04W 28/04

(52) U.S. Cl. CPC H04W 64/00; H04W 28/04

(57) ABSTRACT

A safety system includes a safety controller and a radio location system including a first radio unit, a second radio unit, a reference radio unit, and a testing device. The radio location system is configured to determine a first defined characteristic between the first radio unit and the second radio unit using radio location and to determine a second defined characteristic between the first radio unit and the reference radio unit using radio location. The second defined characteristic is continuously varied according to a pattern known to the testing device. The testing device is configured to generate a confirmation of the first defined characteristic only when the radio location system detects the second defined characteristic varying according to the pattern.

### CROSS-REFERENCE TO RELATED APPLICATIONS

This application claims priority to German patent application 10 2022 118 737.3 filed on 26 Jul. 2022, the entire disclosure of which is incorporated herein by reference.

### FIELD

The present disclosure relates to a safety system for safeguarding a technical installation using a radio location system, and to a radio location system and method.

### BACKGROUND

A radio location system, sometimes referred to as radio navigation system, is a radio-based localization system in which a position of a wirelessly communicating radio unit in a reference system is determined based on characteristics of received radio waves or signals.

Radio location systems are generally known in the prior art. Among the best-known radio location systems are global navigation satellite systems (such as GPS, Galileo, etc.), in which a radio receiver can determine its position in a terrestrial coordinate system on the basis of signals carrying time information transmitted by satellites with known orbits. Furthermore, various indoor radio location systems are known that can be used to determine the position of a radio unit within a building. The most common tracking technologies include Bluetooth Low Energy, WLAN and Ultra-Wideband technology.

Radio location systems may also be used in industrial environments to control processes of autonomously operating machines. By way of example, a radio location systems can be used for driverless vehicles, allowing them to move through an industrial facility without lane guidance. Furthermore, radio location systems may be used in the field of functional safety. In this case, a radio location system may be used to determine positions of various objects (such as people or machines) in an area around a technical installation, and to provide an adaptive safety system with a variable safety configuration based on the position information. In this way, fixed or rigid guards may be dispensed with, allowing more flexible cooperation between people and machines in a common workspace.

By way of example, DE 10 2019 132 024 A1 and EP 3 835 806 A1 each show adaptive safety systems that rely on a radio location system. While DE 10 2019 132 024 A1 describes the localization of a moving machine, EP 3 835 806 A1 shows as an example of position determination of a person equipped with a transponder (radio unit). Both DE 10 2019 132 024 A1 and EP 3 835 806 A1 state that for using position information for adaptive safety systems, the position information of common radio location systems is not reliable enough to be used for safety-critical applications. Accordingly, both disclosures propose to check the measurements of the radio location systems.

DE 10 2019 132 024 A1 proposes to use an additional sensor based on a different principle to verify a position determined by the radio location system independently of the radio location system. In this way, a position of a moving machine can be uniquely identified by two independent characteristics and, in the event that these values differ, a safe state can be brought about to ensure the required safety. However, an additional position measuring system based on a different principle involves considerable expense and is not always feasible for some applications. In addition, with this variant there is the problem that if there is a deviation in the measurement results of the individual position measuring systems, it is not immediately apparent which of the two systems is not functioning properly, so that both systems have to be checked and a diagnostic effort increases.

EP 3 835 806 A1 proposes to determine, in addition to the position provided by the radio location system, two safe distances to anchor objects with a safe distance measuring device according to the “Two-Way-Ranging” (TWR) principle and to determine a protection radius based on the provided position, the safe distances and the known positions of the anchor transponders. Accordingly, it is here an idea to determine the positions of at least two anchor points in addition to the actual object, in order to verify the actual measurement based on the data thus obtained. In contrast to the idea from DE 10 2019 132 024 A1, no additional localization system is required here, but the solution described is susceptible to common-cause errors, for example due to systematic delays in the signal propagation time or changed environmental conditions.

DE 10 2020 102 155 A1 describes a safety system and method for locating an object. According to DE 10 2020 102 155 A1, three radio transponders are provided on the object to be localized, which are arranged at a distance from one another and span a plane that is unique in space. A control and evaluation unit compares the position data of the radio transponders to provide verified position data of the object.

### SUMMARY

Against this background, it is an object of the present disclosure to provide an improved radio location system. In particular, it is an object to provide a radio location system that is better protected against common-cause errors. it is yet another object to provide an improved adaptive safety system based on such a radio location system.

According to an aspect of the present disclosure, there is provided a safety system for safeguarding a technical installation, the safety system comprising a safety controller; and a radio location system comprising a first radio unit; a second radio unit; a reference radio unit; and a testing device; wherein the radio location system is configured to determine a first defined characteristic between the first radio unit and the second radio unit using radio location, wherein the radio location system is further configured to determine a second defined characteristic between the first radio unit and the reference radio unit using radio location, wherein the second defined characteristic is continuously variable according to a pattern known to the testing device, wherein the testing device is configured to generate a confirmation of the first defined characteristic only when the radio location system detects the second defined characteristic changing according to the pattern, and wherein the safety controller is configured to execute or adjust a safety configuration only when the testing device confirms the radio location

According to another aspect, there is provided a radio location method for a radio location system having a first radio unit, a second radio unit, a reference radio unit, and a testing device couplable to the radio location system, the method comprising steps of

determining a first defined characteristic between the first radio unit and second radio unit using radio location;

determining a second defined characteristic between the first radio unit and the reference radio unit using radio location, the second defined characteristic being continuously variable according to a pattern known to the testing device, and

confirming of the first defined characteristic by the testing device in the event that the radio location system, detects the second defined characteristic changing according to the pattern.

According to yet a further aspect, there is provided a radio location system comprising: a first radio unit; a second radio unit; a reference radio unit; and a testing device which can be coupled to the radio location system, the radio location system being configured to determine a first defined characteristic between the first radio unit and the second radio unit using radio location, and to determine a second defined characteristic between the first radio unit and the reference radio unit using radio location, wherein the second defined characteristic is continuously variable according to a pattern known to the testing device, and wherein the testing device is configured to generate a confirmation of the first defined characteristic only when the radio location system detects the second defined characteristic changing according to the pattern.

Thus, it is an aspect of the present disclosure to add a defined testing pattern to a radio location system in order to make the radio location system continuously, dynamically and deterministically verifiable.

The radio location system can be any radio location system in which two radio units determine a defined relationship to each other using radio location in order to be able to draw conclusions about their position, location and/or orientation relative to each other or in a reference system. For example, the radio location system can be a real-time locating system (RTLS) that uses Bluetooth low-energy, WLAN, and/or a ultra-wideband technology-based locating technique.

The first radio unit can be a stationary radio station and the second radio unit can be a portable transponder. In particular, the first radio unit can be an anchor station of the radio location system infrastructure.

For position determination, the radio location system determines a defined first characteristic between the first radio unit and the second radio unit via radio location. For example, the radio location may be based on a signal propagation time between the first radio unit and the second radio unit, where the signal propagation time or a quantity derived therefrom corresponds to the first defined characteristic. Alternatively or complementarily, the radio location can be based on a different principle, so that the first defined characteristic can also be represented by an angle or a signal strength. Preferably, the radio location system may continuously acquire the first defined characteristic.

Further, the radio location system determines a second defined characteristic between the first radio unit and a reference radio unit. The radio location system can also continuously acquire the second defined characteristic. The determination of the second defined characteristic is preferably performed in the same way as the determination of the first defined characteristic between the first radio unit and the second radio unit. That is, the second defined characteristic is preferably the same type of characteristic as the first defined characteristic.

However, unlike the first defined characteristic, the second defined characteristic is variable. In this context, variable means that in a defined time interval or continuously over time, the second defined characteristic takes on a different value when the defined characteristic is determined via radio location.

The change of the second defined characteristic can be caused automatically, directly or indirectly, by the reference radio unit. For example, the reference radio unit can change in a defined manner its actual position within the reference system relevant for radio location, or it can change a signal to be transmitted in a defined manner so that it is recognized by the radio location system as being at a different position. Alternatively or additionally, the testing device can be configured to actively cause the change in the second defined characteristic, for example by the testing device being coupled to the reference radio unit and requesting a change in behavior from the reference radio unit or by the reference radio unit requesting such a change.

The radio location system detects the change in the second defined characteristic by continuously acquiring the second defined characteristic. Furthermore, the radio location system forwards the detected change to the testing device, which checks whether the change corresponds to a defined pattern. The defined pattern, i.e. how the second defined characteristic changes over time, must be known to the testing device. The testing device therefore knows the pattern in advance, specifies it itself, or is made aware of the pattern from an external device.

The testing device checks whether the change corresponds to the pattern. Consequently, the testing device has an expectation of the change of the second defined characteristic over time. If this expectation is met, the testing device confirms the measurement of the first defined characteristic, i.e. the actual, application-relevant measurement. If the expectation is not met, the testing device does not confirm the measurement of the first defined characteristic. To confirm the measurement, the testing device, for example can provide a corresponding enable signal or the testing device can omit providing such a signal.

Confirmation of the measurement occurs only when the testing device detects that the second defined characteristic changes according to the known pattern. In this way, it is possible to check continuously or at certain time intervals whether the radio location is working correctly. The radio location system is thus tested not only actively but also dynamically. In other words, there is always a component in the system that continuously changes in a certain way, so even in a static scenario, the measurement is confirmed by a dynamic component.

Thereby, proper operation of the radio location system can be easily tested. In particular, the radio location system can be checked continuously, dynamically and deterministically in this way. Furthermore, the testing device can be easily integrated into existing radio location systems without having to adapt the radio location systems themselves.

In a preferred refinement, the reference radio unit can be arranged on a reference object that changes the second defined property according to the pattern by changing its position. For example, the reference radio unit can be arranged on an object that moves in a defined manner or on an object whose position can be determined in a predetermined manner. Such a reference object can be a rotating disk or a linear unit moving in a defined manner. It is also conceivable that the reference object is a vehicle or a robot whose position can be made known to the testing device by other means. According to this refinement, a continuously and deterministically changing second defined characteristic can be easily created.

In a further refinement, the reference object can randomly change position, wherein a sensor of the testing device detects the random change in position of the reference object and in this way makes the pattern of change known to the testing device. Thereby, the reference object can be any object that moves continuously in space. It is understood that the detection of the movement can also be used as a supplement in the case of a pre-known pattern.

In a further refinement, the reference radio unit may modify the second defined characteristic by transmitting a modified signal that the radio location system uses to determine the second defined characteristic. In this way, the reference radio unit can change the second defined characteristic without actually moving the reference radio unit. Particularly preferably, the reference radio unit can have spatially spaced antenna units for this purpose, which it uses selectively to modify the signal to be transmitted. The antenna units can be antenna units integrated in the reference radio unit, external antenna units, or a combination of external and internal antenna units. Internal antenna units are those antenna units that are installed in a common housing of the reference radio unit or are linked using a common printed circuit board. External antenna units are antenna units that are connected separately to the radio unit. The use of different antenna units to generate a modified signal has the advantage that commercially available transponders can be used, and a pure software extension may be sufficient to implement this refinement.

In a further refinement, the second defined characteristic changes only in a defined test interval. In this way, a test rate of the radio location system can be set to specific time intervals, allowing the test rate to be flexibly adapted to testing requirements. Thus, for non-critical applications, the test of position determination or a communication test can be performed less frequently than for safety-critical applications. It is also conceivable to adapt the type of pattern depending on the test requirements. For example, a complicated and frequently changing pattern may be used for critical applications, while a simple pattern may suffice for non-critical applications. Overall, the refinement allows the testing device to be adaptable to the test requirements.

In a further refinement, the first defined characteristic and the second defined characteristic are a signal propagation time, a signal propagation time difference, a signal round trip time, a signal incidence angle, a signal strength, a combination thereof, or values derived therefrom. When using ultra-wideband technology for radio location, the first characteristic and the second characteristic may be, for example, the value for UWB-Time-of-Arrival, UWB-Time-Difference-of-Arrival, UWB-Roundtrip-Time-of-Arrival, or UWB-Angle-of-Arrival. Furthermore, the first characteristic and the second characteristic can be based on UWB two-way ranging. In two-way ranging, all tags continuously transmit a location signal and determine the distance to each other from the response.

It is understood that the above features and those to be explained below can be used not only in the combination indicated in each case, but also in other combinations or on their own, without departing from the scope of the present invention.

### BRIEF DESCRIPTION OF THE DRAWINGS

Embodiments of the invention are shown in the drawing and are explained in more detail in the following description.

FIG. 1 shows a schematic diagram of an embodiment of a radio location system according to the present disclosure.

FIG. 2 shows a schematic diagram of a modified example of the embodiment shown in FIG. 1.

FIG. 3 shows a schematic representation of a further modified example of the embodiment shown in FIG. 1.

FIG. 4 shows a schematic representation of an embodiment of a safety system.

FIG. 5 shows a flowchart of an embodiment of a radio location method according to the present disclosure.

### DETAILED DESCRIPTION

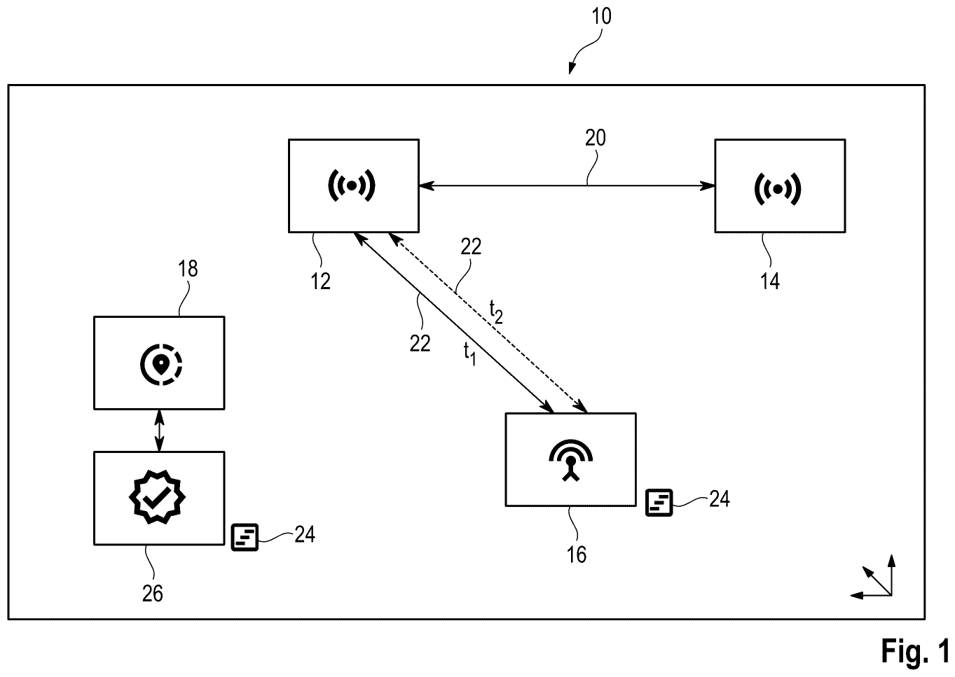

FIG. 1 shows a schematic diagram of an example embodiment of a radio location system including a testing device. The radio location system is designated here in its entirety by reference numeral 10.

The radio location system 10 includes a first radio unit 12, at least one second radio unit 14, and a reference radio unit 16, which are referred to hereinafter simply as radio units when the same characteristics are described for all radio units.

The radio units 12, 14, 16 are devices that can transmit or receive radio signals. In particular, the radio units may be transponders that pick up incoming signals and automatically reply to or forward the received radio signals. The radio units 12, 14, and 16 may be of different designs and may be stationary or mobile devices.

In one example, the first radio unit may be a stationary radio station capable of transmitting and receiving signals. The radio station 12 may include a processing unit configured to process signals. The processing unit may include any commercially available microprocessor or microcontroller. The second radio unit 14 may advantageously be a portable transponder (also referred to as a tag) whose signal processing capability is limited to automatically replying to incoming signals. The reference radio unit 16 may advantageously be a stationary transponder (also referred to as an anchor herein) of which certain properties are known at least to the testing device. It is to be understood that the invention is not limited to this particular setup of the radio units.

The radio location system 10 is configured to determine a first defined characteristic 20, such as a relationship between the first radio unit 12 and the second radio unit 14 and a second defined characteristic, such as relationship 22, 22′ between the first radio unit 12 and the reference radio unit 16. The first defined characteristic 20 and second defined characteristic 22, 22′ may be or may include, by way of example, signal propagation times, signal round-trip times, angles of incidence, signal strengths, or any other quantity that can be used to infer a position, location, and/or orientation of the radio units with respect to a reference system relevant to radio location. It is also conceivable that a combination of the above properties represents the first characteristic and/or the second characteristic.

The first defined characteristic 20 and the second defined characteristics 22, 22′ are preferably of the same type. In particular, an absolute position of the second radio unit 14 in the reference system may be determined from the first defined characteristic 20. Likewise, an absolute position of the reference radio unit 16 may be determined from the second defined characteristic 22, 22′.

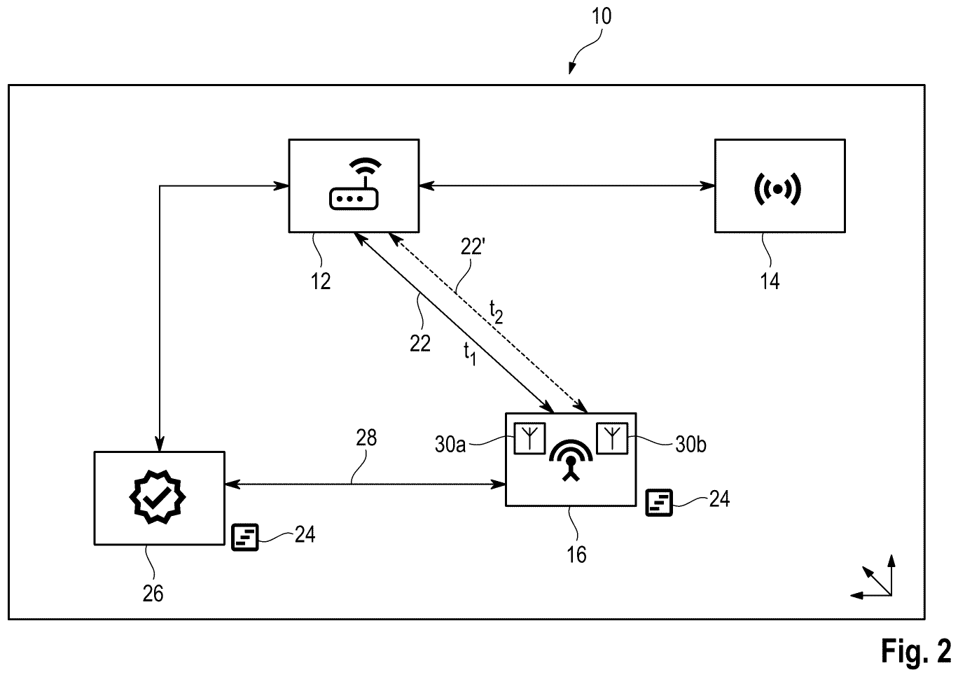

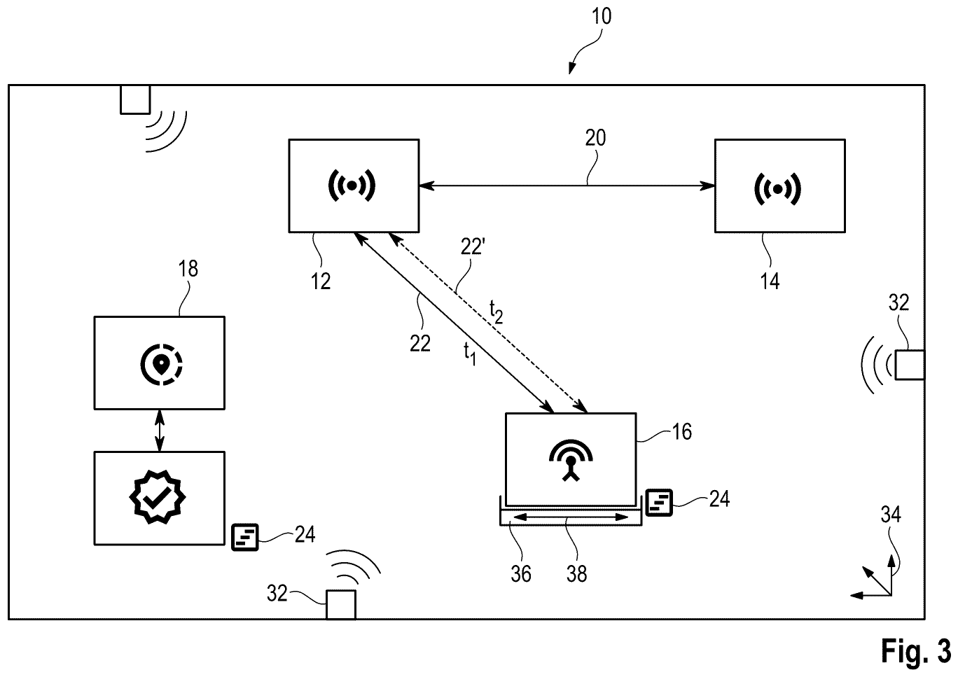

The determination of the characteristics 20, 22, 22′ by the radio location system 16 is schematically indicated here by processing unit 18 and may be performed in various ways in different radio location systems, as indicated, for example, in the embodiments according to FIG. 2 and FIG. 3. It is conceivable that the radio units involved are set up to independently determine the properties among themselves. Alternatively, a central processing unit of the radio location system 10 may determine the defined characteristics of the two radio units relative to each other via a corresponding infrastructure. The testing device described below is not limited to any specific type of radio location.

The second defined characteristic, i.e. the characteristic that is determinable between the first radio unit 12 and the reference radio unit 16, may be variable. That is, a value representing the second defined characteristic may be different at a time t1 than at a time t2, as indicated here by the two separate arrows with reference numerals 22 and 22′. The change in the second defined characteristic 22, 22′ may be caused, for example, by an actual change in position of the reference unit 16, or by transmission of a modified signal by the reference radio unit 16.

The second defined characteristic 22, 22′ may change continuously and preferably in a deterministic manner according to a defined pattern 24. For example, the pattern 24 may specify a rate at which the second defined characteristic changes over time. When all units are functioning properly, the radio location system 10 detects the change of the second defined characteristic according to the defined pattern 24.

A testing device 26 of the radio location system 10 verifies that the radio location system 10 detects whether the second defined characteristic changes according to the pattern 24. If this is the case, the testing device 26 confirms the determination of the first defined characteristic, on the basis of which, for example, the position of the second radio unit 14 can be determined. On the other hand, if the detection deviates from the defined pattern 24 or if the system does not detect any changes at all, the testing device 26 does not confirm the first defined characteristic. For example, the testing device 26 may be a simple switching device and may confirm the first defined characteristic by, for example, an enable signal that is explicitly switched on only when the radio location system 10 detects the second defined characteristic 22, 22′ according to the defined pattern 24. It is also conceivable that the testing device 26 outputs a warning signal if the second defined characteristic 22, 22′ is not detected according to the pattern 24.

Both the testing device 26 and the reference radio unit 16 are aware of the defined pattern 24. In the simplest case, this can be achieved by storing a predefined pattern in the reference radio unit 16 and in the testing device 26. However, it is also conceivable that the reference radio unit 16 and the testing device 26 are coupled together and exchange the pattern 24 by which the change occurs. In one embodiment, the reference radio unit 16 may report the pattern to the testing device 26, for example. In another embodiment, the testing device 26 can be configured to specify the defined pattern 24 and to transmit the defined pattern 24 to the reference radio unit 16. These and other variants of the radio location system are shown below with reference to FIG. 2 and FIG. 3, each of which shows variations and further embodiments of the radio location system 10 according to FIG. 1. The same reference signs indicate the same parts as in FIG. 1.

In the radio location system 10 shown in FIG. 2, the reference radio unit 16 and the testing device 26 are directly coupled to each other. For example, via the coupling 28, the reference radio unit 16 may provide the pattern 24 by which it modifies the second defined characteristic to the testing device 26. Alternatively, via the coupling 28, the reference radio unit 16 may communicate its current position to the testing device 26 so that the testing device 26 can independently infer the pattern 24 thereof. It is likewise conceivable that, via the coupling 28, the testing device 26 specifies the pattern 24 according to which the second defined characteristic is to be changed and provides it to the reference radio unit 16.

For example, in various embodiments, the reference radio unit 16 may be arranged to alternate between a first state and a second state to vary the second defined characteristic. In this case, the testing device 26 may provide a simple clock signal according to which the reference radio unit 16 switches between these two states. The different states may be adopted, for example, by the reference radio unit 16 processing incoming or outgoing signals in the first state with a first antenna unit 30a and in the second state with a second antenna unit 30b, the two antenna units 30a and 30b being spaced apart. It is also conceivable that the reference radio unit 16 indicates the first state by using a first signal and the second state by using a second signal that is different from the first signal.

In addition, in the radio location system 10 shown in FIG. 2, the first radio unit 12 is directly coupled to the testing device 26. Here, the first radio unit 12 is a radio station with its own signal processing, which performs the localization task of the radio location system 10. For example, the first radio unit 12 may send radio signals to the second radio unit 14 and the reference radio unit 16 and use the returning signals to determine the first defined characteristic and the second defined characteristic between the units. From the first defined characteristic and the second defined characteristic in conjunction with a reference information, for example its own position in the reference system, the radio unit 12 can determine specific position information of the second radio unit 14 and the reference radio unit 16.

Further, the first radio unit 12 may transmit the position information to the testing device 26. In this case, the testing device 26 can be a simple comparison unit that has an expectation of the position information based on a stored or provided pattern 24 and compares it to the acquired position information. If the position information for the reference radio unit 16 changes in accordance with the pattern 24, it can be assumed that the radio location by the first radio unit 12 is operating properly, so that the position information with respect to the second radio unit 14 can also be assumed to be correct.

FIG. 3 shows another embodiment of a radio location system according to the present disclosure. In this embodiment, the radio location system 10 is an infrastructure-based locating system. In addition to the radio units 12, 14, 16 to be located, the radio location system 10 includes here a plurality of fixed anchor stations 32 and a central processing unit 18.

Here, the radio location system 10 is configured to determine positions of the radio units 12, 14, 16 in the reference system 34 via the anchor stations 32 via triangulation. Based on the position information of each radio unit 12, 14, 16, the radio location system 10 can infer defined characteristics (first and second characteristics) between the radio units 12, 14, 16. For example, the radio location system 10 may determine a distance between the two units based on the location information. Thus, in this embodiment, the radio location system infrastructure measures, while the objects to be measured are simple transponders.

As previously described, the reference radio unit 16 is configured to continuously change the second defined characteristic. In the present embodiment, the radio unit 16 is arranged for this purpose on a reference object 36, which moves in a defined manner in the reference system 34. The movement indicated here is a linear movement 38 along an axis of the reference system 34. The linear movement 38 occurs in a specific manner representing the pattern 24. The pattern 24 in which the movement occurs is known to the testing device 26. For example, the reference object 36 may be a linear unit that is movable between two fixed positions such that at a time t1 the reference radio unit 16 is at a first location and at a time t2 it is at a second location. Depending on the location of the reference radio unit 16, a different second defined characteristic 22, 22′ is obtained.

By knowing at what time the reference radio unit 16 is at what location (pattern 24), the testing device 26 can verify proper operation of the radio location.

With reference to FIG. 2 and FIG. 3, two different embodiments of the radio location system 10 have been described above. It is understood that the different variants by which the reference radio unit 16 is configured to change the second defined characteristic 22, 22′ can be combined. For example, the linear unit shown in the embodiment according to FIG. 3 can be used as a reference radio unit 16 in the embodiment according to FIG. 2, and vice versa. Similarly, a reference radio unit 16 according to the second embodiment may be used in an infrastructure-based radio location system according to FIG. 3. The present disclosure is not limited to any particular setup.

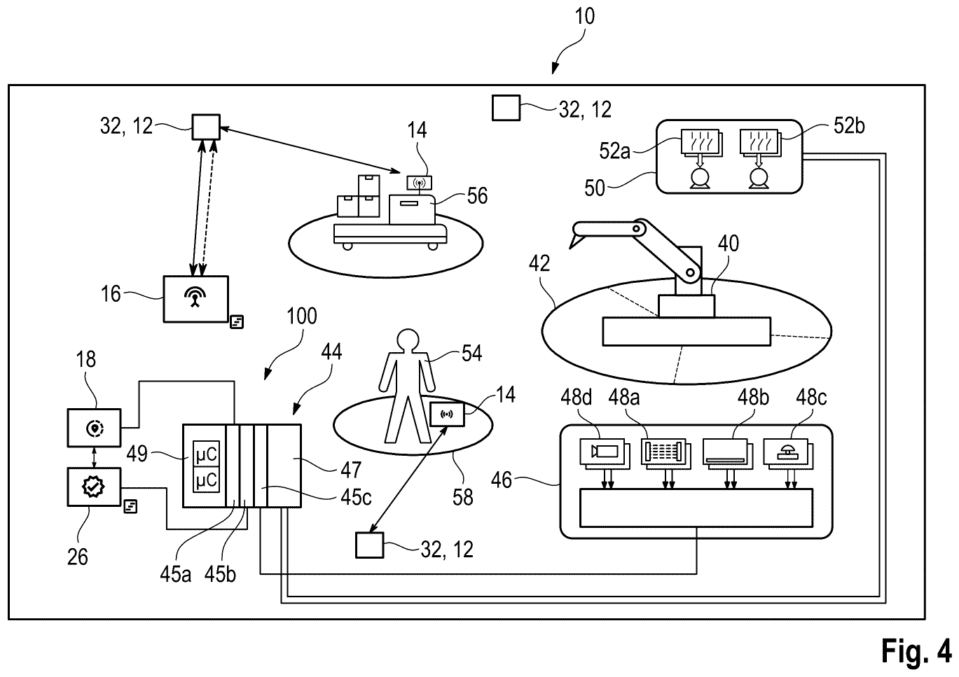

FIG. 4 shows a safety system according to an embodiment of the present disclosure. In FIG. 4, the safety system as a whole is designated by reference numeral 100.

The safety system 100 is used to protect people or objects from a technical installation, here shown as an industrial robot 40. The work area of the industrial robot 40 defines a protected area 42 within which any access is to be monitored. Monitoring is provided by a safety controller 44, which can be connected on the input side to safety devices 46, such as light barriers 48a, safety mats 48b, emergency stop buttons 48c, safe cameras 48d, etc., and on the output side to actuators 50, for example contactors in a power supply 52a, 52b of the technical installation. The safety controller performs a safety-related control function depending on the input signals provided by the safety devices 46 and acts on the outputs. If, for example, a person 54 or an autonomously operating vehicle 56 enters the protected area 42, this can be detected by the safety devices 46 connected to the safety controller 44 and the industrial robot 40 can be transferred to a safe state by switching off the power supply 52a, 52b.

In this example, the safety controller 44 is a modular safety controller having several input modules 45a, 45b, 45c, an output module 47, and a header module 49 in a module array. “Modular” here means that the number of input modules and output modules can be varied according to requirements by adding additional input and output modules to the module array.

Like a “normal” standard controller (also called a programmable logic controller (PLC)), a safety controller performs control functions. However, in contrast to a normal controller, a safety controller has additional safety-related equipment, which can ensure fail-safe execution of the safety function. Thus, the safety control regularly differs from a normal controller by two separate channels for processing, a diversified structure with different hardware, constant tests of inputs and outputs, constant comparisons of user data, voltage and time monitoring, as well as by a safe shutdown in case of error or danger.

In the present example, the safety controller 44 is also an adaptive safety controller. “Adaptive” in this context means that the safety function performed by the safety controller 44, hereinafter also referred to as the safety configuration, can change dynamically depending on an input parameter. For example, the input parameter may be position information of an object located in the work area, the position information being provided by a previously described radio location system 10 of the safety controller 44.

In one example of use, for example, the position information of a driverless transport vehicle 56 can be used to inhibit the safety-related control function, in this case the safe shutdown of the industrial robot 40, when the vehicle 56 enters the protective area 42 of the industrial robot 40. In another example, the positional information of a person 54 can be used to dynamically adjust the size of the protected area 42. For this purpose, for example, a protective space 58 can be defined around the person 54 based on the position information, according to which the protective area 42 is to be defined. It goes without saying that these application examples are only examples, and that there are other possible constellations in which a dynamic safety configuration can be put to use.

The position information may be determined using one of the previously described locating systems 10 and transmitted, for example, from a central processing unit 18 of the radio location system 10 to the safety controller 44. The radio units 12-14 are distributed in the working space, with one radio unit arranged at each of the moving objects whose position is to be determined. In the example illustrated herein, the radio units at the objects correspond to second radio units 14 as defined in this disclosure, and the first radio units 12 as defined in this disclosure coincide with the anchor stations 32 of the radio location system in this example.

Furthermore, the radio location system 10 comprises at least one reference radio unit 16 and a corresponding testing device 26. The testing device 26 verifies proper operation of the radio location system 10 in the manner previously described and confirms the position information acquired by the radio location system 10. For this purpose, the testing device 26 may be connected to an input module 45b of the safety controller 44, like a regular safety sensor, and provide an enable signal as long as proper operation of the radio location system is determined based on the verification via the dynamic reference radio unit 16.

The safety controller 44 is configured to execute or adjust the safety configuration based on the position information only when the enable signal is present at the input module 45b of the safety controller 44. In the present case, the safety controller 44 is configured to allow operation of the industrial robot 40 only when the enable signal from the testing device 26 is present at an input of the input module 45b of the safety controller 44. For this purpose, the safety controller 44 controls the output module 47 such that contactors 50 connected to the output module 47 and arranged in the power supply 52a, 52b of the industrial robot 40 are only energized (activated) when the enable signal is applied to the input module 45b.

Thus, the safety controller 44 can execute control based on position information from the radio location system 10 without having to check the position information itself via an additional device independent of the radio location system. Rather, it is sufficient for the safety controller 44 to receive the enable signal from the testing device 26 via another input module and to control the output module 47 in accordance with the enable signal. The testing device 26 thus corresponds to a further safety device 46 and the safety controller 44 does not itself have to carry out a comparison of two position information of different sensors, but only has to process a further input signal.

It is understood that more sophisticated test procedures are possible with the devices described above. For example, the radio location system can be configured to transmit a distance between two radio units determined via a first radio location method to one of the radio units which also measures the distance between the two radio units via a second radio location method different from the first and compares it to the received distance. Diversity can be further increased by using another radio location method. In addition, this aspect can be combined with the previously described dynamic measurement, in which one of the radio units also dynamically changes its position. The reliability of the overall system can thus be further increased.

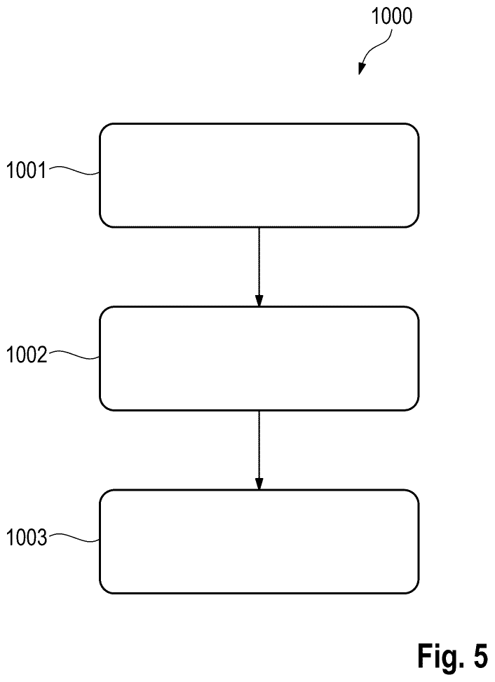

Finally, FIG. 5 shows a schematic flowchart of an embodiment of a method for a radio location system with a testing device. The method is designated in its entirety by reference numeral 1000.

In a first step 1001, the radio location system determines a first defined characteristic between a first radio unit and a second radio unit within the radio location system using a radio location. Here, radio location is not limited to a specific measurement procedure. In particular, the first defined characteristic may be the position or location of the first and second radio units in a reference system of the radio location system, or a defined relationship between the two radio units, such as a distance between them.

In a second step S1002, the radio location system determines a second defined characteristic between the first radio unit and a reference radio unit preferably via the same radio location means. In particular, the radio location system performs one continuous measurement or at least two measurements at different times to determine a change over time of the second defined characteristic. The change of the second defined characteristic occurs according to a known pattern.

Finally, in step S1003, a testing device coupled to the radio location system confirms whether the radio location system has detected the second defined characteristic changing according to the pattern. For this purpose, the testing device can check whether the values determined by the radio location system for the second defined characteristic correspond to the known pattern. If this is the case, the testing device can send out an enable signal as confirmation, which is further processed by a safety controller, for example.

The foregoing embodiments of the radio location system, the safety system, and the method are generally intended to be examples only, without limiting the subject matter of the present disclosure. Rather, the subject matter is defined and limited solely by the following claims.

1. A safety system for safeguarding a technical installation, the safety system comprising:
a safety controller; and
a radio location system including:
a first radio unit;
a second radio unit;
a reference radio unit; and
a testing device, wherein:
the radio location system is configured to determine a first defined characteristic between the first radio unit and the second radio unit using radio location,
the radio location system is further configured to determine a second defined characteristic between the first radio unit and the reference radio unit using radio location,
the second defined characteristic is continuously variable according to a pattern known to the testing device,
the testing device is configured to generate a confirmation of the first defined characteristic only when the radio location system detects the second defined characteristic changing according to the pattern, and
the safety controller is configured to execute or adjust a safety configuration only when the testing device confirms the radio location.

2. The safety system of claim 1 wherein the reference radio unit is arranged at a reference object that changes the second defined characteristic according to the pattern by a change in position.

3. The safety system of claim 2 further comprising:
a sensor couplable to the testing device,
wherein the sensor detects the change in position of the reference object to make the pattern known to the testing device.

4. The safety system of claim 3 wherein the reference object randomly changes its position.

5. The safety system of claim 1 wherein the reference radio unit is configured to transmit and vary a signal representing the second defined characteristic to change the second defined characteristic according to the pattern.

6. The safety system of claim 5 wherein:
the reference radio unit includes a first antenna unit and a second antenna unit, and
the reference radio unit transmits the signal selectively with the first antenna unit or the second antenna unit to modify the signal according to the pattern.

7. The safety system of claim 1 wherein the reference radio unit is configured to change the second defined characteristic only in a defined test interval.

8. The safety system of claim 1 wherein the first defined characteristic and the second defined characteristic each include at least one of a signal propagation time, a signal propagation time difference, a signal round trip time, a signal incidence angle, a signal strength, a combination thereof, or values derived therefrom.

9. The safety system of claim 1 wherein the first radio unit is an anchor station of the radio location system having a fixed position within a reference system underlying the radio location system.

10. The safety system of claim 1 wherein the second radio unit is a mobile transponder that picks up incoming signals and responds automatically.

11. The safety system of claim 1 wherein the first defined characteristic represents at least one of a position information or location information defined between the first radio unit and the second radio unit.

12. The safety system of claim 1 wherein the second defined characteristic represents at least one of a position information or location information defined between the first radio unit and the reference radio unit.

13. The safety system of claim 1 wherein the testing device is configured to output an enable signal to the safety controller to confirm the radio location by the radio location system.

14. The safety system of claim 13 wherein the safety controller is configured to put the technical installation into a safe state if the safety controller does not receive the enable signal.

15. The safety system of claim 13 wherein the safety controller is configured to switch the technical installation off if the safety controller does not receive the enable signal.

16. The safety system of claim 13 wherein the safety controller is configured with multi-channel redundancy in order to evaluate the enable signal in a fail-safe manner.

17. A method for operating a radio location system having a first radio unit, a second radio unit, a reference radio unit, and a testing device, the method comprising:
determining a first defined characteristic defining a relationship between the first radio unit and the second radio unit using radio location;
determining a second defined characteristic defining a relationship between the first radio unit and the reference radio unit using radio location;
varying the second defined characteristic according to a pattern known to the testing device, and
in response to the radio location system detecting the second defined characteristic changing according to the pattern, confirming the first defined characteristic by the testing device.

18. A radio location system comprising:
a first radio unit;
a second radio unit;
a reference radio unit; and
a testing device, wherein:
the radio location system is configured to determine a first defined characteristic between the first radio unit and the second radio unit using radio location and to determine a second defined characteristic between the first radio unit and the reference radio unit using radio location,
the second defined characteristic is continuously variable according to a pattern known to the testing device, and
the testing device is configured to generate a confirmation of the first defined characteristic only when the radio location system detects the second defined characteristic changing according to the pattern.
